(19) United States
(12) Patent Application Publication
(10) Pub. No.: US 2016/0366528 A1
(43) Pub. Date: Dec. 15, 2016

(54) COMMUNICATION SYSTEM, AUDIO SERVER, AND METHOD FOR OPERATING A COMMUNICATION SYSTEM

(71) Applicant: Sony Mobile Communications, Inc., Tokyo (JP)

(72) Inventors: Magnus Landqvist, Lund (SE); Fredrik Johansson, Malmo (SE); Jonas Gustavsson, Lomma (SE); Hakan Jonsson, Malmo (SE); Peter lsberg, Lund (SE); Olivier Moliner, Lund (SE); Ola Thorn, Limhamn (SE); Magnus Midholt, Lund (SE)

(21) Appl. No.: 14/737,287

(22) Filed: Jun. 11, 2015

(51) Int. Cl. H04R 27/00; G06K 9/00

(52) U.S. Cl. CPC H04R 27/00; G06K 9/00348; G06K 9/00288

(57) ABSTRACT

The present invention relates to a communication system, an audio server, and a method for operating a communication system.

### BACKGROUND OF THE INVENTION

The present invention relates to a communication system, especially to a so called intercom system for communicating between places or within rooms of a building, an industrial plant or site, for example at home or within a company. The present invention relates furthermore to an audio server supporting the communication or intercom system, and to a method for operating the communication system.

### BRIEF SUMMARY OF THE INVENTION

According to an embodiment, a communication system comprises a plurality of communication devices and at least one processing device which is coupled to the plurality of communication devices. A first communication device of the plurality of communication devices comprises an environmental information receiving device and an audio output device. A second communication device of the plurality of communication devices comprises an audio input device. The processing device is configured to identify a person from a group of persons in an environment of the first communication device based on an environmental information received by the environmental information receiving device of the first communication device. For example, the environmental information receiving device of the first communication device may comprise an audio input device, and the processing device may be configured to receive acoustic signals via the audio input device, to determine acoustic gait information of a person walking in the environment of the first communication device based on the received acoustic signals, and to identify the person by an acoustic gait recognition based on the acoustic gait information. The group of persons may be predefined or preconfigured, or the communication system may automatically add persons to the group of persons whenever identifying characteristics of a person can be determined, e.g. by a self learning mechanism. E.g. a person is walking around and the steps are recorded for gait recognition. Furthermore, a device identifier (e.g. a Bluetooth or Wi-Fi ID) associated with the person or a voice identifying the person is captured and based on this information the person may be added together with identifying characteristics to the group of persons. Another way to add persons automatically to the group of persons may be the following: A Person is asking a question directed to a person, e.g. “Jane, are you at home”. When the person positively answers this question, the person's voice, gait and e.g. identifying devices (e.g. a mobile phone identifier) may be used to determine characteristics for identifying a person which may be added to the group of persons.

The processing device is furthermore configured to receive a speech message form the second communication device via the audio input device of the second communication device, and to determine an addressee of the speech message. The addressee of the speech message may be determined based on a content of the speech messages, for example when the uttered speech message includes a name of the addressee at or near the beginning of the speech message. Additionally or as an alternative, the addressee may be determined based on a user input received via a user interface of the communication system, e.g. via buttons which are assigned to addressees. The addressee corresponds to a person of the group of persons. The processing device determines if the determined addressee corresponds to the person identified in the environment of the first communication device. In case the addressee corresponds to the person identified in the environment of the first communication device, the processing device directs the speech message to the first communication device, and the speech message directed to the first communication device is output via the audio output device of the first communication device to the addressee. Intercommunication devices, so called intercom systems, for communicating within places or rooms of a building, an industrial plant or site or at home are well known in the art. In general, an intercom system relates to a stand alone voice communication system for use within a building or small collection of buildings. Communication devices are mounted or placed at several locations within the building, for example in each room of the building. The communication devices are connected to each other for enabling voice communication between the communication devices. For establishing a voice communication, an initiator of the voice communication selects one or more communication devices to which a following voice message is to be transmitted. Thus, the destination of a voice message is selected based on a location of the selected communication device. However, the initiator of a voice communication may want to address a specific person. Therefore, as described in the communication system above, the processing device is configured to identify a person from a group of persons in an environment of a communication device based on environmental information received by the communication device. Thus, the processing device knows which person is located in the environment of which communication device. Furthermore, an addressee of a speech message is determined, e.g. based on a content of the speech message, for example by extracting the name of the addressee from the speech message by means of a speech recognition technique. The speech message may than be forwarded or directed to the communication device in which environment the addressed person is situated, and the speech message may be output by the corresponding communication device to the addressed person.

In some embodiments and as already mentioned above, the processing device is configured to receive acoustic signals via the audio input device of the first communication device, and to determine acoustic gait information of a person walking in the environment of the first communication device based on the received acoustic signals. Based on the acoustic gait information, the processing device identifies the person by using an acoustic gait recognition technique. This enables the processing device to identify a person from a group of persons. With a digital processing of the received acoustic signals and the use of machine learning, the probability of identification of a person form a large group of persons (1000 of persons) may be in a range of 58 to 65%. For a limited group of persons (for example a view 10) the probability of proper identification may be up to 98%. As the communication device of an intercom system usually provide both, a loudspeaker and a microphone, acoustic signals in the environment of the communication devices may be continuously received with low additional effort. Based on the acoustic gait recognition, the processing device may monitor the environment of each of the communication devices such that the presence of a specific person in the environment of a communication device may be continuously determined.

In some embodiments, the processing device is configured to track the identified person in the environment of the first communication device based on environmental information received by the environmental information receiving device of the first communication device. In particular, once a person has been identified to be in the environment of a specific communication device, the identified person may be tracked for example by further acoustic gait recognition. For example, the tracking may comprise monitoring that the identified person is leaving the environment of one communication device and entering the environment of another communication device which is located in a neighbouring room of the one communication device. By tracking, a recognition rate of the gait recognition may be increased.

According to another embodiment, the environmental information receiving device of the first communication device comprises an audio input device and a person from a group of persons is identified in the environment of the first communication device based on voice information. In particular, the processing device is configured to receive acoustic signals via the audio input device of the first communication device, and to determine voice information of a person in the environment of the first communication device based on the received acoustic signals. Based on the voice information the person is identified by the processing device. The voice based identification may be used in combination with the gait based identification to increase the probability of a proper identification of the person. Furthermore, in case the person is not walking around, the person may be identified by the voice information. However, the voice information may be determined based on the same acoustic signals received via the audio input device of the first communication device as the acoustic signals used in the gait recognition. Therefore, the voice based recognition may be easily implemented with low additional effort in the communication system.

According to yet another embodiment, the environmental information receiving device of the first communication device comprise an optical input device, and a person from a group of persons is identified based on optical gait information. For accomplishing this, the processing device is configured to receive optical information via the optical input device of the first communication device, to determine optical gait information of a person walking in the environment of the first communication device based on the received optical information, and to identify the person by an optical gait recognition based on the optical gait information. In case an optical input device is available at the communication device, the optical gait recognition may contribute to increase the probability of a proper identification of the person.

Furthermore, for identifying a person of the group of persons, the processing device may be configured to receive optical information via the optical input device of the first communication device, to determine optical face information of the person in the environment of the first communication device based on the received optical information, and to identify the person by a face recognition based on the optical face information.

In some embodiments, the environmental information receiving device of the first communication device comprises a transceiver device, for example a transmitter and a receiver for transmitting and receiving radio signals. For identifying a person from the group of persons, the processing device is configured to connect to a mobile device in the environment of the first communication device via the transceiver device, to request user information of a user to which the mobile device is assigned from the mobile device, and to identify the person based on the requested user information. For example, if the person is using a mobile device, for example a mobile telephone, the first communication device may identify the person based on the mobile telephone the person is carrying around. This information may be used solely or in combination with the above described methods to properly identify a person from the group of persons. As an alternative, the mobile device may comprise for example a headset, in particular a Bluetooth headset, or a mobile gaming device which is currently used by the person.

In some embodiments the processing device is comprised in an audio server of the communication system. The audio server is coupled to the plurality of communication devices via a data communication network, for example via a local area network (LAN) or a wireless local area network (VVLAN). For example, the audio server may comprise an interface to the internet or the world wide web for providing a cloud based speech processing to determine the addressee of the speech message, or for providing further services to the communication devices, for example providing a music output based on a request from the person in the environment of the communication devices, or for providing a question answering by querying a data basis in the internet based on questions from the person in the environment of the communication device.

According to another embodiment, a subgroup is defined by a subgroup indicator and a plurality of persons of the group of persons who are assigned to the subgroup. The processing device is configured to determine an addressee of the speech message, for example based on a content of the speech message, and to direct the speech message to the first communication device, if the determined addressee corresponds to the subgroup indicator and if the person identified in the environment of the first communication device is assigned to the subgroup. By defining a subgroup, a speech message may be directed to a plurality of persons who are assigned to the subgroup. Therefore, a multi cast or broadcast of a speech message may be enabled, wherein the speech message is directed only to those communication devices which are arranged near at least one of the persons assigned to the subgroup.

In another embodiment, an audio server comprises a data interface for interfacing to a plurality of communication devices, and a processing device. A first communication device of the plurality of communication devices comprises an environmental information receiving device and an audio output device. A second communication device of the plurality of communication devices comprises an audio input device.

The processing device is configured to identify a person from a group of persons in an environment of the first communication device based on environmental information received by the environmental information receiving device of the first communication device, to receive a speech message from the second communication device via the audio input device of the second communication device, to determine an addressee of the speech message, for example based on a content of the speech message, wherein the addressee corresponds to a person of the group of persons, to direct the speech message to the first communication device, if the determined addressee corresponds to the person identified in the environment of the first communication device, and to output the speech message directed to the first communication device via the audio output device of the first communication device. Thus, the audio server enables, for example when being used in an intercom system, to determine where a person of the group of persons is located with respect to communication devices, and to direct a speech message to the corresponding communication device based on an addressee information of the speech message.

Another embodiment relates to a method for operating a communication system. The communication system comprises a plurality of communication devices and at least one processing device coupled to the plurality of communication devices. A first communication device of the plurality of communication devices comprises an environmental information receiving device and an audio output device. A second communication device of the plurality of communication devices comprises an audio input device. According to the method, a person from a group of persons is identified in an environment of the first communication device by the processing device based on environmental information received by the environmental information receiving device of the first communication device. Furthermore, a speech message is received at the processing device from the second communication device via the audio input device of the second communication device. The processing device determines an addressee of the speech message, for example based on a content of the speech message. The addressee corresponds to a person of the group of persons. Furthermore, the processing device directs the speech message to the first communication device, if the determined addressee corresponds to the person identified in the environment of the first communication device. The speech message directed to the first communication device is output via the audio output device of the first communication device.

Although specific features described in the above summary and the following detailed description are described in connection with specific embodiments, it is to be understood that the features of the embodiments described herein can be combined with each other unless specifically noted otherwise.

### BRIEF DESCRIPTION OF THE DRAWINGS

The present invention will now be described in more detail with referenced the accompanying drawings.

FIG. 1 shows schematically a communication system according to an embodiment of the present invention.

FIG. 2 shows schematically a communication system according to another embodiment of the present invention.

FIG. 3 shows a flowchart comprising method steps for operating a communication system according to an embodiment of the present invention.

### DESCRIPTION OF PREFERRED EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or indirect coupling unless specifically noted otherwise.

Speech recognition and processing of spoken language are getting commonly used in all kinds of applications. For example, voice assistance in mobile phones is available which support a user of a mobile phone to set up a telephone call, to retrieve information from the internet or to control applications running on the mobile phone. Comparable voice assistance are getting used in automobiles for controlling functions of the automobile, for example for entering a destination into a navigation system. The accuracy of the speech recognition and language interpretation may be increased by connecting to servers in the internet, so called cloud connection, enabling the assistant to tap into a world of knowledge provided by the World Wide Web. Furthermore, voice command devices may use speech recognition and language interpretation for several functions including question answering, playing music and controlling smart devices. A voice command device may comprise a speaker, a microphone array and an internet connection. The voice command device may listen continuously to all conversations monitoring for a predefined wake-up word to be spoken. A voice recognition capability may be based on web services provided in the internet. Upon detecting the wake-up word, questions may be automatically answered, a command for controlling smart devices may be executed, or a requested piece of music may be played back automatically. Due to the uncomplex structure the connectivity and the high practical value, voice command devices may be arranged in many locations, for example in many rooms at home or in an office building.

On the other hand, intercom systems for use within a building or small collection of buildings are commonly used. By use of speech recognition, a usability of an intercom system may be enhanced, as will be shown in the following.

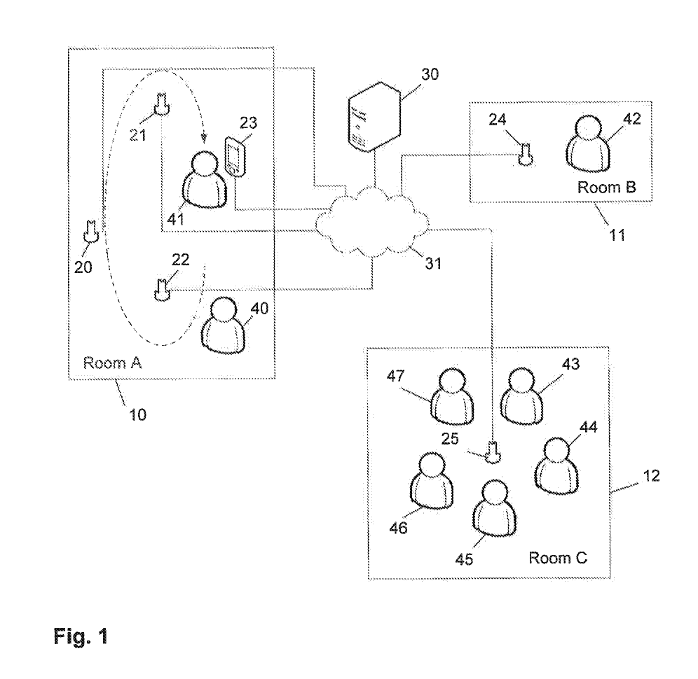

FIG. 1 shows a communication system configured to enable a communication between persons arranged in room A 10, room B 11 and room C 12. The communication system comprises a plurality of communication devices 20-25. Communication devices 20-23 are arranged in room A 10, communication device 24 is arranged in room B 11, and communication device 25 is arranged in room C 12. The communication system comprises furthermore a processing device 30 which is coupled to the communication device 20-25 via a data communication network 31, for example a local area network, a wireless local area network, and/or a wireless or wired internet connection. For example, the processing device 30 may be provided as a cloud service in the internet. Additionally or as an alternative, the processing device 30 may comprise a server in a building comprising rooms 10-12, or the processing device 30 may comprise a plurality of processing devices arranged within or coupled to the communication devices 20-25. The communication devices 20-25 may each comprise a microphone for receiving audio signals in an environment of the corresponding communication device, a loudspeaker for outputting audio signals, and an environmental information receiving device which will be described later in more detail. The communication devices 20-25 are configured to receive audio signals and to forward corresponding audio data to the processing device 30. Furthermore, the communication devices 20-25 are configured to receive audio output data from the processing device 30 and to output audio signals in response to received audio data. The audio signals received and output by the communication devices 20-25 may comprise speech, music and any other kind of noise.

In the rooms 10-12 persons may be located, for example, two persons 40 and 41 may be located in room A 10, one person 42 may be located in room B 11 and five persons 43-47 may be located in room C 12.

The processing device 30 continuously tries to identify which persons are located in which room. To accomplish this, the processing device 30 receives environmental information from the environmental information receiving devices of each of the communication devices 20-25. Based on the received environmental information, the processing device identifies a person in an environment of each of the communication devices. For identifying a person, characteristics of the person which may be captured with the environmental information receiving devices are evaluated. For example, a group of persons may be predefined in the processing device and characteristics of the received environmental information may be compared to characteristics of the predefined group of persons to identify a person from the predefined group of persons. In particular, a person may be identified or recognized by the way the person walks. This recognition type is also known as gait recognition or gait-based person identification. Gait recognition may be performed based on visual information, but also based on acoustic information. Therefore, the environmental information receiving device of the communication devices 20-25 may comprise a camera or the microphone of the corresponding communication device. The gait-based person identification may also rely on information from an accelerometer acting as the environmental information receiving device of a communication device which is carried around by a user as a mobile device.

Communication device 23 in FIG. 1 may comprise for example a mobile phone, gaming device or music playback device which may be carried around by person 41 and which may comprise an accelerometer providing information which may be used to identify the person 41 based on gait characteristics of person 41. However, an audio based gait recognition may be implemented at low cost and may provide reliable gait-based person identification at a low data transmission rate via the communication network 31 and at low computing power in the processing device 30. In case a plurality of communication devices are provided within one room, for example as shown in FIG. 1 in connection with room A 10, the communication devices 20-22 may identify person 40 when the person 40 is walking in the room, for example along the dashed arrow shown in FIG. 1. In this case, the communication devices 20-22 may additionally determine which communication device is currently closest to person 40.

When any of the persons 40-47 is talking the speech is received by the communication devices 20-25 which are near the corresponding speaker, i.e., by those communication devices which are arranged in the same room as the talking person. For example, when person 40 or 41 is talking, the speech may be received by communication device 20, communication device 21, and/or communication device 22. Likewise, when person 42 is talking, the speech may be received by communication device 24. When any one of persons 43-47 is talking, the speech may be received by communication device 25. The speech is received via the audio input device of the corresponding communication device, in particular via the microphone or an array of microphones. The received speech is transmitted from the communication devices 20-25 to the processing device 30 which analyzes the received speech. In particular, the processing device 30 analyses the speech first by a speech recognition and than by a content analysis. The content analysis figures out if the speech message is addressed to a person. This may be accomplished by comparing names mentioned in the speech message to the group of persons defined in the processing device 30. Furthermore, the content may be analyzed to determine if the speech message is directed to this person. If the determined addressee of the analyzed speech message corresponds to a person who has been identified in an environment of a communication device in another room, the speech message is directed to the corresponding communication device. For example, if person 40 utters a message which is addressed to “Anna” and Anna has been identified as person 45 in room C 12, the speech message received at communication device 22 is directed to communication device 25 and output via the audio output device, for example a loudspeaker, at the communication device 25.

Instead of addressing a single person, specific subgroups may be defined in the processing device 30. For example, in case the communication system of FIG. 1 is installed in a hospital, subgroups relating to for example nurses or doctors may be defined. In the example shown in FIG. 1 persons 42-44 may be assigned to the nurses' subgroup. When person 40 utters a speech message with the addressee “nurses”, this speech message may be automatically forwarded to communication devices 24 and 25. Additionally, in some embodiments, there is no need to address a specific person or a specific group of persons. For example, a question like “Is anyone at home?” may automatically be forwarded to and output at all communication devices.

As described above, the gait or walking style, which is very specific and individual for each person, has emerged as a way to identify individual persons with for example a camera, accelerometer or microphone. Therefore, the communication devices 20-25 continuously monitor gait information and identify the persons in the corresponding areas. Additionally, the communication devices 20-25 may continuously track voice characteristics and classify these to be able to identify the persons in that area. Furthermore, the communication devices 20-25 may scan and connect to mobile devices of the persons to determine who is in the environment of the communication device. The processing device 30, for example an audio server, may contribute to analyze the environmental information received by the communication devices 20-25 and to identify where which person is located. Based on this information the processing device 30 may forward messages from one communication device to another.

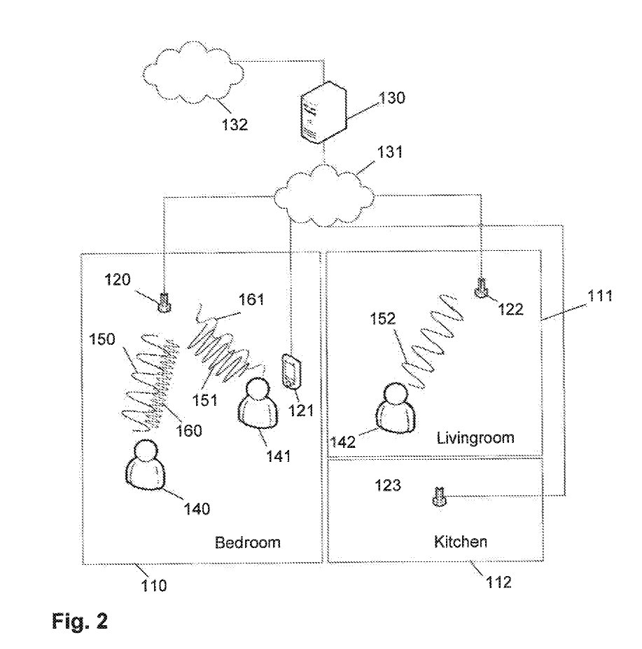

FIG. 2 shows another embodiment of a communication system comprising a plurality of communication devices 120-123 and a processing device 130 coupled to the communication devices 120-123 via a data communication network 131, for example a home network. The processing device 130 may comprise for example and audio server which may be coupled to the internet 132. The communication system may be installed in a home environment. For example, communication devices 120 and 121 may be arranged in a bedroom 110, communication device 122 may be arranged in a living room 111, and communication device 123 may be arranged in a kitchen 112. The communication devices 120, 122, and 123 may be stationary communication is devices, whereas, communication device 121 may be a mobile communication device, for example a mobile phone, a mobile music player, a table computer, a wearable computer or a mobile gaming device. The communication devices may comprise for example the above described voice command devices or may comprise for example television devices, radio devices, or gaming devices. Each of the persons 140-142 generates acoustic gait information 150-152 which may be received by the communication devices 120-123 when the person is walking in an environment of the corresponding communication device. For example, acoustic gait signals 150 are generated by person 140 and received by communication device 120. Likewise, acoustic gait signals 151 are generated by person 141 and received by communication device 120, as persons 140 and 141 are located in an environment of communication device 120. Acoustic gait signals 152 are generated by person 142 and received by communication device 122 when person 142 is walking around in an environment of communication device 122. The received acoustic gait signals are digitised by the communication devices 120 and 122 and transmitted via the home network 131 to the audio server 130. The audio server 130 identifies persons 140, 141 and 142 based on the received gait information and determines a current location of each of the persons 140, 141 and 142. The arrangement of the communication devices 120, 122, and 123 in the rooms 110-112 is known by the audio server 130. Therefore, the audio server 130 knows which person is located in which room.

The audio server 130 listens furthermore to speech received by the communication devices 120-123. For example, the audio server 130 may receive a speech message 160 from person 140 comprising “Where is Anna?”. Person 142 may have been identified as Anna before based on the acoustic gait signal 152. Therefore, the audio server 130 may reply via communication device 120 “Anna is in the living room”. Furthermore, person 141 may utter the message 161 “Anna, what are you doing?”.

The audio server 130 recognizes by analyzing the content of the message 161 that the message is assigned to person 142. Therefore, the message is forwarded to communication device 122 and output via a loudspeaker of communication device 122. A response from the person 142 to person 141 may be directed by the audio server 130 to communication device 121 as this communication device is located more closer to person 141 than communication device 120. Communication device 121 may comprise for example a personal mobile device of person 141, for example a mobile telephone or a mobile gaming device. Thus, privacy of a communication may be achieved.

The communication system may also block an audio output to person 141 via communication device 120 upon detecting other persons near person 141, for example upon detecting person 140, to keep the privacy in the conversation.

In both communication systems described above, the communication system may track the persons, for example by gait recognition or voice recognition to make the system more robust.

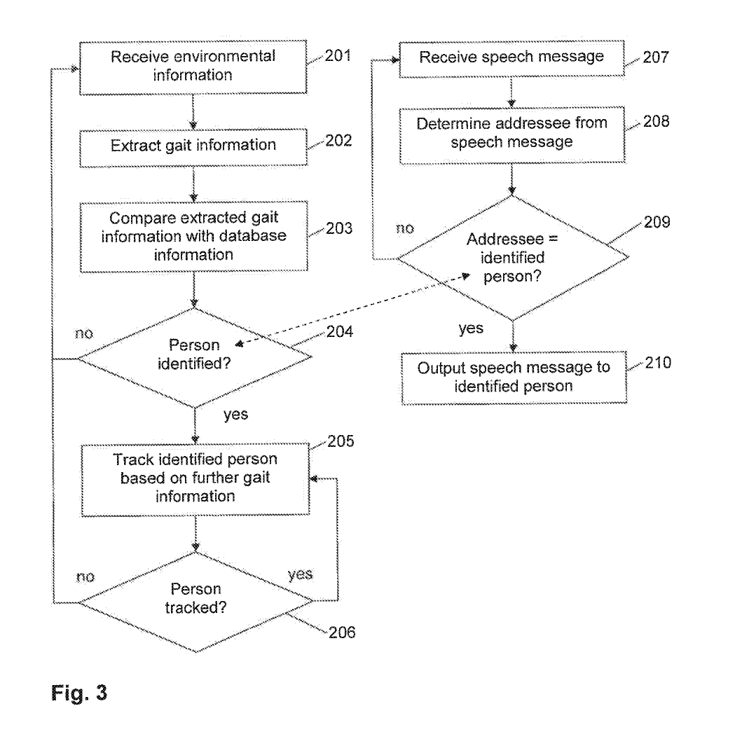

The gait tracking will be described below in more detail in connection with FIG. 3. In step 201 the processing device 30 or the audio server 130 receives environmental information from the communication devices 20-25 and 120-123, respectively, comprising audio gait signals. In step 202 gait information is extracted and in step 203 the extracted gait information is compared with gait characteristics for a predefined group of persons of for example a data base. If in step 204 a person could be identified based on the gait information, the identified person is tracked in step 205 based on further gait information. In parallel, a speech message received in step 207 may be analyzed in step 208 to determine an addressee of the speech message and the addressee may be compared with the identified persons in step 209. In case there was a match between the addressee and an identified person in step 209, the speech message may be forwarded and output to the identified person in step 210. To keep the information about all identified persons up to date, in steps 205 and 206 the identified persons are continuously tracked based on the further gait information. By tracking the person in a limited area of the corresponding communication device, a high reliability may be achieved. Furthermore, the tracking of the person may help to identify the person when the person is moving from one area to another, i.e. when the person is moving from an environment of one communication device to an environment of another communication device. To sum up, after a gait detection and a person identification, the system enters a tracking state to be able to hold the identification in that area.

What is claimed is:

1. A communication system comprising a plurality of communication devices and at least one processing device coupled to the plurality of communication devices, wherein a first communication device of the plurality of communication devices comprises an environmental information receiving device and an audio output device, and a second communication device of the plurality of communication devices comprises an audio input device, and
wherein the processing device is configured:
to identify a person from a group of persons in an environment of the first communication device based on environmental information received by the environmental information receiving device of the first communication device,
to receive a speech message from the second communication device via the audio input device of the second communication device,
to determine an addressee of the speech message, wherein the addressee corresponds to a person of the group of persons,
to direct the speech message to the first communication device, if the determined addressee corresponds to the person identified in the environment of the first communication device, and
to output the speech message directed to the first communication device via the audio output device of the first communication device.

2. The communication system according to claim 1, wherein the processing device is configured to determine the addressee of the speech message based on a content of the speech message.

3. The communication system according to claim 1, wherein the processing device is configured to determine the addressee of the speech message based on a user input via a user interface of the communication system.

4. The communication system according to claim 1, wherein the environmental information receiving device of the first communication device comprises an audio input device, wherein, for identifying a person from the group of persons, the processing device is configured to receive acoustic signals via the audio input device of the first communication device, to determine acoustic gait information of a person walking in the environment of the first communication device based on the received acoustic signals, and to identify the person by an acoustic gait recognition based on the acoustic gait information.

5. The communication system according to claim 1, wherein the processing device is configured to track the identified person in the environment of the first communication device based on environmental information received by the environmental information receiving device of the first communication device.

6. The communication system according to claim 1, wherein the environmental information receiving device of the first communication device comprises an audio input device, wherein, for identifying a person from the group of persons, the processing device is configured to receive acoustic signals via the audio input device of the first communication device, to determine voice information of a person in the environment of the first communication device based on the received acoustic signals, and to identify the person based on the voice information.

7. The communication system according to claim 1, wherein the environmental information receiving device of the first communication device comprises an optical input device, wherein, for identifying a person from the group of persons, the processing device is configured to receive optical information via the optical input device of the first communication device, to determine optical gait information of a person walking in the environment of the first communication device based on the received optical information, and to identify the person by an optical gait recognition based on the optical gait information.

8. The communication system according to claim 1, wherein the environmental information receiving device of the first communication device comprises an optical input device, wherein, for identifying a person from the group of persons, the processing device is configured to receive optical information via the optical input device of the first communication device, to determine optical face information of a person in the environment of the first communication device based on the received optical information, and to identify the person by a face recognition based on the optical face information.

9. The communication system according to claim 1, wherein the environmental information receiving device of the first communication device comprises a transceiver device, wherein, for identifying a person from the group of persons, the processing device is configured to connect to a mobile device in the environment of the first communication device via the transceiver device, to request user information of a user to which the mobile device is assigned from the mobile device, and to identify the person based on the requested user information.

10. The communication system according to claim 9, wherein the mobile device comprises at least one of a group consisting of:
a mobile telephone,
a headset,
a mobile gaming device,
a tablet computer, and
a wearable computer.

11. The communication system according to claim 1, wherein the processing device is comprised in an audio server of the communication system, the audio server being coupled to the plurality of communication devices via a data communication network.

12. The communication system according to claim 1, wherein a subgroup is defined by a subgroup indicator and a plurality of persons of the group of persons who are assigned to the subgroup, wherein the processing device is configured:
to determine an addressee of the speech message based on a content of the speech message, and
to direct the speech message to the first communication device, if the determined addressee corresponds to the subgroup indicator and if the person identified in the environment of the first communication device is assigned to the subgroup.

13. An audio server, comprising:
a data interface for interfacing to a plurality of communication devices, wherein a first communication device of the plurality of communication devices comprises an environmental information receiving device and an audio output device, and a second communication device of the plurality of communication devices comprises an audio input device, and
a processing device configured:
to identify a person from a group of persons in an environment of the first communication device based on environmental information received by the environmental information receiving device of the first communication device,
to receive a speech message from the second communication device via the audio input device of the second communication device,
to determine an addressee of the speech message, wherein the addressee corresponds to a person of the group of persons,
to direct the speech message to the first communication device, if the determined addressee corresponds to the person identified in the environment of the first communication device, and
to output the speech message directed to the first communication device via the audio output device of the first communication device.

14. A method for operating a communication system, the communication system comprising a plurality of communication devices and at least one processing device coupled to the plurality of communication devices,
wherein a first communication device of the plurality of communication devices comprises an environmental information receiving device and an audio output device, and a second communication device of the plurality of communication devices comprises an audio input device,
wherein the method comprises the steps of:
identifying, by the processing device, a person from a group of persons in an environment of the first communication device based on environmental information received by the environmental information receiving device of the first communication device,
receiving, at the processing device, a speech message from the second communication device via the audio input device of the second communication device,
determining, by the processing device, an addressee of the speech message, wherein the addressee corresponds to a person of the group of persons,
directing, by the processing device, the speech message to the first communication device, if the determined addressee corresponds to the person identified in the environment of the first communication device, and
outputting the speech message directed to the first communication device via the audio output device of the first communication device.
